(19) United States
(12) Patent Application Publication
(10) Pub. No.: US 2012/0003352 A1
(43) Pub. Date: Jan. 5, 2012

(54) LIQUID-CENTER GUM COMPOSITION

(76) Inventors: Hayato Kajiura, Tokyo (JP); Masaki Yanazaki, Tokyo (JP)

(21) Appl. No.: 12/672,513

(22) PCT Filed: Aug. 5, 2008
(86) PCT No.: PCT/JP08/64378

§ 371 Date: Feb. 7, 2010

(30) Foreign Application Priority Data
Aug. 9, 2007 (JP) 2007-208437

(51) Int. Cl. A23G 4/20; A23G 4/10

(52) U.S. Cl. 426/5

(57) ABSTRACT

The present invention is to provide a liquid-center gum composition having a gum portion and a liquid portion covered with the gum portion, in which moisture migration from the liquid portion to the gum portion with time can be reduced and desired texture and flavor can be maintained over time. The liquid-center gum composition according to the present invention has a gum portion and a liquid portion covered with the gum portion and characterized in that the gum portion consists of a sugar component and a gum base and the sugar component contains at least one of erythritol and mannitol.

### TECHNICAL FIELD

The present invention relates to a liquid-center gum composition, and more particularly, to a liquid-center gum composition comprising a gum portion and a liquid portion covered with the gum portion.

### BACKGROUND ART

Liquid-center gum (hereinafter referred to as “LC gum”) comprising a gum portion and a liquid portion covered with the gum portion, which is chewing gum filled with a liquid containing, for example, a sweetener, has been already known in the art.

Conventional LC gum has a problem in that moisture migrates from a liquid portion to a gum portion with the passage of time, degrading a commercial value of the LC gum. To describe the problem more specifically, when moisture migration occurs, the moisture of the liquid portion first reduces, changing the texture of LC gum when chewed. As a result, desired texture cannot be obtained. Secondly, an aqueous flavor and a taste component contained in the liquid portion migrate to the gum portion together with the moisture, changing the taste of the liquid portion such as flavor. As a result, desired taste cannot be obtained.

To solve these problems, various methods have been proposed for modifying the composition of the liquid portion covered with a gum portion (U.S. Pat. Nos. 3,894,154, 4,156,740, 4,157,402, and 4,466,983). U.S. Pat. No. 3,894,154 is directed to a method of manufacturing a center-in gum by adding a water-miscible moisturizer to a liquid portion for retarding viscosity increase. U.S. Pat. No. 4,156,740 is directed to a method of manufacturing a center-in gum by adding a glycerin moisturizer and another moisturizer to a liquid portion. U.S. Pat. No. 4,157,402 is directed to a method of enhancing flavor-retaining property of a liquid portion by adding an emulsifying agent to a liquid portion. U.S. Pat. No. 4,466,983 is directed to a method of manufacturing a center-in gum by adding a specific component such as glycerin to a liquid portion. In these methods, attempts are made to reduce moisture reduction of a liquid portion caused by migration of moisture from the liquid portion to a gum portion. However, in the LC gum pieces manufactured by these conventional methods, the aforementioned problem has not yet been solved.

On the other hand, to solve these problems, a method for modifying the composition of a gum portion is also proposed (National Publication No. 2007-511214, International Publication WO2006/026298). In National Publication No. 2007-511214, an intermediate layer is arranged between the outer coating and the core containing a liquid to suppress migration of moisture from the core to a minimum level. The publication proposes that the intermediate layer may be made of gum arabic, maltodextrin or another appropriate binder, or alternatively, made of another constitutional element such as sugar alcohol (e.g. maltitol). However, this method has a problem. Since the intermediate layer is newly (additionally) formed, a manufacturing method becomes complicated. International Publication WO2006/026298 proposes that a polyol composition made of maltitol is contained in a gum portion. However, in the gum composition of International Publication WO2006/026298, migration of moisture from a liquid-filled region to a gum region is not sufficiently reduced.

### DISCLOSURE OF THE INVENTION

The present invention was made to solve the conventional problems mentioned above. It is an object of the present invention to provide a liquid-center gum (LC gum) composition comprising a gum portion and a liquid portion covered with the gum portion, in which moisture migration from the liquid portion to the gum portion with time can be reduced and desired texture and flavor can be maintained over time.

An LC gum composition according to the present invention comprises a gum portion and a liquid portion covered with the gum portion, characterized in that the gum portion consists of a sugar component and a gum base and the sugar component contains at least one of erythritol and mannitol.

In the LC gum composition of the present invention, the content of at least one of erythritol and mannitol relative to the total weight of the gum portion is preferably 40.0 wt % to 75.0 wt %, more preferably, 54.0 wt % to 65.0 wt %, and most preferably, 57.5 wt % to 63.0 wt %.

In the LC gum composition of the present invention, the content of at least one of erythritol and mannitol relative to the total weight of the gum portion is 40.0 wt % to 75.0 wt % and the content of the gum base relative to the total weight of the gum portion is 22.0 wt % to 46.5 wt %.

Furthermore, in the LC gum composition of the present invention, it is preferable that the content of at least one of erythritol and mannitol relative to the total weight of the gum portion is 54.0 wt % to 65.0 wt % and the content of the gum base relative to the total weight of the gum portion is 23.5 wt % to 32.5 wt %.

Moreover, in the LC gum composition of the present invention, it is the most preferable that the content of at least one of erythritol and mannitol relative to the total weight of the gum portion is 57.5 wt % to 63.0 wt % and the content of the gum base relative to the total weight of the gum portion is 23.5 wt % to 29.0 wt %.

In the LC gum composition of the present invention, the gum portion may further contain at least one element selected from the group consisting of a sugar component excluding erythritol and mannitol, a sweetener, an emulsifying agent, an acidulant, a flavor and a softening agent.

In the LC gum composition of the present invention, the liquid portion may contain glycerin.

The LC gum composition of the present invention has an effect of reducing migration of moisture from a liquid portion to a gum portion with time, thereby maintaining desired texture and flavor over time by use of at least one of erythritol and mannitol as a sugar component. In addition, erythritol and mannitol have appropriate flexibility and moldability (easy-to-mold) and thus readily applicable to a conventional manufacturing method and apparatus.

### BEST MODES FOR CARRYING OUT THE INVENTION

The LC gum composition of the present invention comprises a gum portion primarily consisting of a sugar component and a gum base and a liquid portion covered with the gum portion and the sugar component contains at least one of erythritol and mannitol. The at least one of erythritol and mannitol reduces moisture migration (a conventional problem) from the liquid portion to the gum portion with time.

The gum portion of the LC gum composition of the present invention plays a role in covering the liquid portion to be filled therein and providing intrinsic nature of a gum composition such as chewiness and texture. The gum portion herein consists of principally a gum base and a sugar component.

The sugar component of the gum portion of an LC gum composition according to the present invention principally comprises at least one of erythritol and mannitol. The content of at least one of erythritol and mannitol is generally 40.0 wt % to 75.0 wt %, preferably 40.0 wt % to 73.4 wt %, more preferably, 54.0 wt % to 65.0 wt %, and most preferably, 57.5 wt % to 63.0 wt %, relative to the total weight of the gum portion.

The gum base of the gum portion of an LC gum composition according to the present invention can be appropriately selected from the gum bases used in conventional LC gum compositions, if desired.

Generally, the gum base can be selected from various types of polymers, hydrophilic colloids, polyols and/or mixtures thereof known in the art.

Furthermore, the gum portion of the LC gum composition of the present invention may further contain at least one element selected from the group consisting of a sugar component excluding erythritol and mannitol, a sweetener, an emulsifying agent, an acidulant, a flavor and a softening agent.

In the gum portion of the LC gum composition of the present invention, the blending ratio of at least one of erythritol and mannitol serving as a sugar component relative to the gum base is as follows. Generally, at least one of erythritol and mannitol is contained in an amount of 40.0 wt % to 75.0 wt % and the gum base in an amount of 22.0 wt % to 46.5 wt % relative to the total weight of the gum portion. Preferably, at least one of erythritol and mannitol is contained in an amount of 40.0 wt % to 73.4 wt % and the gum base in an amount of 22.0 wt % to 46.5 wt % relative to the total weight of the gum portion. More preferably, at least one of erythritol and mannitol is contained in an amount of 54.0 wt % to 65.0 wt % and the gum base in an amount of 23.5 wt % to 32.5 wt % relative to the total weight of the gum portion. Most preferably, at least one of erythritol and mannitol is contained in an amount of 57.5 wt % to 63.0 wt % and the gum base in an amount of 23.5 wt % to 29.0 wt % relative to the total weight of the gum portion. Then, the remaining component of the gum portion of each of these formulations is at least one element selected from the group consisting of a sugar component excluding erythritol and mannitol, a sweetener, an emulsifying agent, an acidulant, a flavor and a softening agent.

Furthermore, in the LC gum composition of the present invention, sugar coating, candy-film and granular coating may be applied to the exterior of the gum portion.

The LC gum composition of the present invention can be manufactured by use of a conventional manufacturing method and apparatus (National Publication Nos. 2004-506434 and 2004-508024). The manufacturing apparatus as disclosed in National Publication No. 2004-506434 is an apparatus for continuously manufacturing tablets of an LC gum composition. In the apparatus, a rope-form gum composition which is filled with a liquid is formed and molded by extrusion. After adjusting the dimensions thereof, the gum composition is separated into tablets individually filled with the liquid. The apparatus has a tablet-forming mechanism having a chain mechanism consisting of pairs of grooved die members (open-form dies mutually combined). By virtue of the structure, a rope-form gum composition is separated and formed into individual pellets.

Examples of the present invention will be explained below; however, the present invention is not limited by the examples explained below.

### Example 1

As a sugar component of the LC gum composition of the present invention, erythritol (this example), mannitol (this example), maltitol (comparative example), xylitol (comparative example), sorbitol (comparative example) and palatinit (comparative example) were used. The formulations of other gum components and liquid components are shown in Tables 1 and 2. A gum portion (blended at a temperature 50° C. and kneaded for 20 minutes) and a liquid portion (blended at a temperature of 30 to 50° C. for 20 minutes) were separately manufactured. Using the aforementioned manufacturing apparatus, LC gum tablets (each having dimensions: 17.5 mm length×12.5 mm width×7.5 mm thickness and having a weight of about 1.2 g, and LC gum tablets each having dimensions: 21.7 mm length×15.0 mm width×8.0 mm thickness and having a weight of about 1.8 g) were manufactured.

TABLE 1
Formulation of gum portion of LC gum
composition

| Component of gum portion | % by weight |
|---|---|
| Gum base | 27.8 |
| Sugar component | 58.7 |
| Maltitol | 8.9 |
| Sweetener having a high degree of | 0.2 |
| sweetness | |
| Emulsifying agent | 0.1 |
| Acidulant | 1.9 |
| Flavor | 1.4 |
| Sofenening agent | 1.0 |
| Total | 100.0 |

TABLE 2
Formulation of liquid portion of LC gum
composition

| Component of liquid portion | % by weight |
|---|---|
| Maltitol syrup (Bx. 75) | 47.00 |
| Sorbitol syrup (Bx. 70) | 3.93 |
| Acidulant (citric acid) | 8.18 |
| Glycerin | 40.00 |
| Sweetener having a high degree of | 0.16 |
| sweetness | |
| Colorant | 0.04 |
| Flavor | 0.18 |
| Thickening agent | 0.51 |
| Total | 100.00 |

LC gum tablets were manufactured first by blending the gum portion and the liquid portion of an LC gum composition in accordance with predetermined formulations. The compositions of the gum portion and the liquid portion were separately loaded to an extruder to form a rope-form LC gum material in which the liquid portion is covered with the gum portion. Subsequently, the rope-form LC gum material was supplied to a manufacturing apparatus as disclosed in National Publication No. 2004-506434 to manufacture tablets of the LC gum composition in a continuous manner.

### (Evaluation Test)

The LC gum tablets thus manufactured (each having dimensions: 17.5 mm length×12.5 mm width×7.5 mm thickness and a weight of about 1.2 g) were sealed with an aluminum-evaporated packaging material and accelerated aging was performed at 40° C. One week later, the solid-content value (hereinafter referred to as “Bx.”) of the center-filled liquid was measured. Bx. was measured by a commercially available Bx.-meter. The Bx.-meter is generally an instrument for measuring the concentration of solid-content in a liquid. In principle, an optical refractive index increases with an increase of the concentration of solid-content. Based on the principal, measurement is performed. Bx. is an index basically showing the concentration of solid-content of a liquid; however it was used herein as an index showing the moisture content (flowability) of the liquid portion, for convenience sake. Glycerin (purity: 100%) used herein as a raw material is free form the concept of concentration. However, when glycerin is measured by the commercially available Bx.-meter, it shows the same refractive index (Bx. 73) as in maltitol syrup. Accordingly, in this test, the value indicated by the Bx.-meter was used in evaluation of moisture amount (flowability) even in a system containing glycerin.

Note that, measurement was performed at room temperature (20° C.). A change with the passage of time observed during the storage performed at a temperature of 40° C. for a week corresponds to a change with the passage of time observed during the normal storage performed at normal temperature for 3 months.

The solid content of the center-filled liquid is derived from the solid contents of raw-material syrup (maltitol syrup, sorbitol syrup) and other raw materials. When the moisture of a liquid portion derived from raw material syrup migrates to a gum portion, the moisture of the liquid portion reduces and relatively Bx. increases.

The Bx. measurement results and the qualitative evaluation results of LC gum tablets are shown in Tables 3 and 4 below. Furthermore, an evaluation test was performed with respect to LC gum tablets each having dimensions: 21.7 mm length×15.0 mm width×8.0 mm thickness and a weight of about 1.8 g, in the same manner as above. As a result, no difference was observed in results (change with time) between the LC gum tablets each having dimensions: 17.5 mm length×12.5 mm width×7.5 mm thickness and a weight of about 1.2 g and the LC tablets each having dimensions: 21.7 mm length×15.0 mm width×8.0 mm thickness and a weight of about 1.8 g.

TABLE 3
Change of Bx. with time by difference of
the sugar component of gum portion

| Sugar component | Bx. before | Bx. one week after |
|---|---|---|
| of gum portion | aging test | initiation of aging test |
| Erythritol | 73.0 | 73.5 |
| Mannitol | 73.0 | 73.5 |
| Maltitol | 73.0 | 74.5 |
| Xylitol | 73.0 | 75.5 |
| Sorbitol | 73.0 | 75.5 |
| Palatinit | 73.0 | 77.9 |

(Unit: %)

TABLE 4
Quality evaluation of gum portion by difference of sugar component

| | Erythritol | Mannitol | Maltitol | Xylitol | Sorbitol | Palatinit |
|---|---|---|---|---|---|---|
| Bx. | 73.5 | 73.5 | 74.5 | 75.5 | 75.5 | 77.9 |
| Reduction | AA | AA | C | C | C | C |
| in | | | | | | |
| moisture | | | | | | |
| migration | | | | | | |
| Flavor | AA | AA | AA | AA | AA | AA |
| Mold- | AA | AA | AA | AA | AA | AA |
| ability | | | | | | |

### (Criteria of Quality Evaluation)

Evaluation criteria of moisture migration of Table 4 were set as follows:

AA: Bx.73.0 to 73.5,

A: Bx.73.6 to 73.8,

B: Bx.73.9 to 74.0,

C: Bx.74.1 or more.

Flavor/moldability was evaluated based on sensory evaluation or production-line aptitude by visual observation in accordance with the following criteria:

AA: Very excellent,

A: Excellent,

B: Acceptable,

C: No good.

In the case of the LC gum composition of the present invention, where erythritol and mannitol were used, the amount of moisture migrated from a liquid portion to a gum portion is low and an increase of Bx. was suppressed, compared to comparative examples where maltitol, xylitol, sorbitol and palatinit were used. In addition, in the cases where erythritol and mannitol were used, LC gum tablets equivalent or excellent in all features such as reduction of moisture migration, flavor and moldability were obtained, compared to the case where other sugar components were used.

### Examples 2 to 13

Generally in LC gum containing a large amount of gum base, the amount of moisture migrating from the liquid portion to the gum portion is low. Therefore, the lower limit of the gum-base content was set at 22.0 wt %. The amounts of the sugar component (erythritol and maltitol) of the gum portion of an LC gum composition according to the present invention and the gum base thereof were set in accordance with the blending ratio as shown in Tables 5 and 6. The remaining content of the gum portion was set in accordance with that of Example 1. A liquid portion was set to principally contain glycerin as shown in Table 2. In this way, LC gum tablets of Examples 2 to (each having dimensions: 17.5 mm length×12.5 mm width×7.5 mm thickness and a weight of about 1.2 g) were manufactured in the same manner as in Example 1.

TABLE 5
Formulation of gum portion of LC gum
composition (examples of the invention) using
erythritol (Part 1)

| | Ex. 2 | Ex. 3 | Ex. 4 | Ex. 5 | Ex. 6 | Ex. 7 |
|---|---|---|---|---|---|---|
| Erythritol | 73.4 | 70.0 | 68.0 | 67.0 | 65.0 | 63.0 |
| Maltitol | 0 | 3.4 | 5.4 | 6.4 | 6.9 | 8.9 |
| Gum base | 22.0 | 22.0 | 22.0 | 22.0 | 23.5 | 23.5 |

The unit of a value in the table is % by weight.

TABLE 6
Formulation of gum portion of LC gum
composition (examples of the invention) using
erythritol (Part 2)

| | Ex. 8 | Ex. 9 | Ex. 10 | Ex. 11 | Ex. 12 | Ex. 13 |
|---|---|---|---|---|---|---|
| Erythritol | 60.0 | 57.5 | 54.0 | 51.0 | 46.5 | 40.0 |
| Maltitol | 8.9 | 8.9 | 8.9 | 8.9 | 8.9 | 8.9 |
| Gum base | 26.5 | 29.0 | 32.5 | 35.5 | 40.0 | 46.5 |

The unit of a value in the table is % by weight.

### Comparative Examples 1 to 3

As comparative examples of the present invention, LC gum tablets of Comparative Examples 1 to 3 having compositions of Table 7 (having dimensions: 17.5 mm length×12.5 mm width×7.5 mm thickness and a weight of about 1.2 g) were manufactured in the same manner as in Example 1.

TABLE 7
Formulation of gum portion of LC gum
composition (comparative examples) using erythritol

| | Com. Ex. 1 | Com. Ex. 2 | Com. Ex. 3 |
|---|---|---|---|
| Erythritol | 39.0 | 35.0 | 80.0 |
| Maltitol | 16.0 | 20.0 | 0 |
| Gum base | 40.4 | 40.4 | 15.4 |

The unit of a value in the table is % by weight.

### (Evaluation Test)

The Bx. measurement and a quality evaluation test of LC gum tablets were performed in the same manner as in Example 1. The results are shown in Tables 8 to 10 below.

TABLE 8
Change of Bx. with time by difference of
the erythritol content of gum portion (part 1)

| | Ex. 2 | Ex. 3 | Ex. 4 | Ex. 5 | Ex. 6 | Ex. 7 |
|---|---|---|---|---|---|---|
| Bx. | 73.8 | 73.8 | 73.8 | 73.8 | 73.5 | 73.5 |
| Reduction | A | A | A | A | AA | AA |
| in moisture | | | | | | |
| migration | | | | | | |
| Flavor | AA | AA | AA | AA | AA | AA |
| Moldability | A | A | A | A | A | AA |

TABLE 9
Change of Bx. with time by difference of
the erythritol content of gum portion (part 2)

| | Ex. 8 | Ex. 9 | Ex. 10 | Ex. 11 | Ex. 12 | Ex. 13 |
|---|---|---|---|---|---|---|
| Bx. | 73.5 | 73.5 | 73.5 | 73.5 | 73.2 | 73.2 |
| Reduction | AA | AA | AA | AA | AA | AA |
| in moisture | | | | | | |
| migration | | | | | | |
| Flavor | AA | AA | A | A | B | B |
| Moldability | AA | AA | AA | A | A | A |

TABLE 10
Change of Bx. with time by difference of
the erythritol content of gum portion (part 3)

| | Com. Ex. 1 | Com. Ex. 2 | Com. Ex. 3 |
|---|---|---|---|
| Bx. | 73.2 | 73.2 | 74.5 |
| Reduction in | AA | AA | C |
| moisture migration | | | |
| Flavor | C | C | A |
| Moldability | C | C | B |

As is apparent from Tables 8 to 10, in the case where the content of erythritol in an LC gum composition according to the present invention exceeds 80 wt %, since the ratio of a gum base becomes low, moisture migration increases and Bx. increases. However, when the content of erythritol is 73.4 wt % or less, Bx. is low and the moisture migration from a liquid portion to a gum portion is low. Furthermore, when Bx. of Example 2 (erythritol: 73.4 wt %) is compared to that of Comparative Example 3 (erythritol: 80.0 wt %), it is presumed that Bx. decreases and moisture migration decreases when the erythritol content is 75.0 wt % or less. On the other hand, when erythritol is less than 39.0 wt %, even if the moisture migration decreases, flavor and moldability degrade. Based of overall evaluation of the reduction in moisture migration in view of flavor and moldability, it was found that LC gum tablets reduced in moisture migration and having excellent flavor and moldability are obtained generally at an erythritol content of 40.0 wt % to 75.0 wt %, preferably at 40.0 wt % to 73.4 wt %, more preferably, at 54.0 wt % to 65.0 wt %, and most preferably, at 57.5 wt % to 63.0 wt %.

### Examples 14 to 18, Comparative Examples 4 to 6

The moisture migration from a liquid portion to a gum portion was evaluated by conducting tests in which the content of glycerin serving as a main component of the liquid portion of an LC gum composition was changed to those shown in Table 11. As the component of the gum portion, erythritol was primarily employed as a main sugar component, similarly to those shown in Table 1.

Moisture migration from a liquid portion to a gum portion was evaluated based on the same Bx. measurement as in Example 1. The results are shown in Table 11.

TABLE 11
Change of Bx. with time by difference of glycerin content of liquid
portion

| | Ex. | Ex. | Ex. | Ex. | Ex. | Ex. | Com. | Com. | Com. |
|---|---|---|---|---|---|---|---|---|---|
| | 14 | 15 | 16 | 17 | 18 | 19 | Ex. 4 | Ex. 5 | Ex. 6 |
| Glycer- | 40 | 50 | 60 | 70 | 80 | 90 | 25 | 95 | 100 |
| in | | | | | | | | | |
| content | | | | | | | | | |
| (wt %) | | | | | | | | | |
| Bx. (%) | 73.5 | 73.5 | 73.0 | 73.0 | 73.0 | 73.0 | 74.5 | 73.0 | 73.0 |

The unit of glycerin content is % by weight relative to the total weight of a liquid portion.

In the LC gum composition of the present invention, when a glycerin content relative to the total weight of the liquid portion is 40 wt % to 90 wt %, in particular, 60 wt % to 90 wt %, moisture migration from a liquid portion to a gum portion decreased. When the glycerin content exceeds 90 wt %, moisture migration to a gum portion decreases; however, it becomes difficult to dissolve optional additives in a liquid portion, with the result that it is difficult to control flavor and texture of the liquid. The resulting gum is disqualified as an LC gum product. When the glycerin content is less than 40 wt %, the moisture of a liquid portion migrates to a gum portion. The resultant gum product lost a sense of moisture and texture deteriorated.

### Examples 20 to 31

LC gum tablets of Examples 20 to 31 (each having dimensions: 17.5 mm length×12.5 mm width×7.5 mm thickness and a weight of about 1.2 g) were manufactured in the same manner as in Example 1, except that mannitol was used in place of erythritol in a blending ratio as shown in Tables 12 and 13, the remaining components of the gum portion followed Example 1, and a liquid portion primarily contained glycerin as a main component, as shown in Table 2.

TABLE 12
Formulation of gum portion of LC gum
composition (examples of the invention) using
mannitol (Part 1)

| | Ex. 20 | Ex. 21 | Ex. 22 | Ex. 23 | Ex. 24 | Ex. 25 |
|---|---|---|---|---|---|---|
| Mannitol | 73.4 | 70.0 | 68.0 | 67.0 | 65.0 | 63.0 |
| Maltitol | 0 | 3.4 | 5.4 | 6.4 | 6.9 | 8.9 |
| Gum base | 22.0 | 22.0 | 22.0 | 22.0 | 23.5 | 23.5 |

The unit of a value in the table is % by weight.

TABLE 13
Content of gum portion of LC gum
composition (examples of the invention) using
mannitol (Part 2)

| | Ex. 26 | Ex. 27 | Ex. 28 | Ex. 29 | Ex. 30 | Ex. 31 |
|---|---|---|---|---|---|---|
| Mannitol | 60.0 | 57.5 | 54.0 | 51.0 | 46.5 | 40.0 |
| Maltitol | 8.9 | 8.9 | 8.9 | 8.9 | 8.9 | 8.9 |
| Gum base | 26.5 | 29.0 | 32.5 | 35.5 | 40.0 | 46.5 |

The unit of a value in the table is % by weight.

### Comparative Examples 7 to 9

As comparative examples of the present invention, LC gum tablets (each having dimensions: 17.5 mm length×12.5 mm width×7.5 mm thickness and a weight of about 1.2 g) of Comparative Examples 7 to 9 having compositions of Table 14 were manufactured in the same manner as in Example 1.

TABLE 14
Formulation of gum portion of LC gum
composition (comparative examples) using mannitol

| | Com. Ex. 7 | Com. Ex. 8 | Com. Ex. 9 |
|---|---|---|---|
| Mannitol | 39.0 | 35.0 | 80.0 |
| Maltitol | 16.0 | 20.0 | 0 |
| Gum base | 40.4 | 40.4 | 15.4 |

The unit of a value in the table is % by weight.

### (Evaluation Test)

The Bx. measurement and a quality evaluation test of LC gum tablets were performed in the same manner as in Example 1. The results are shown in Tables 15 to 17 below.

TABLE 15
Change of Bx. with time by difference of
the mannitol content of gum portion (part 1)

| | Ex. 20 | Ex. 21 | Ex. 22 | Ex. 23 | Ex. 24 | Ex. 25 |
|---|---|---|---|---|---|---|
| Bx. | 73.8 | 73.8 | 73.8 | 73.8 | 73.5 | 73.5 |
| Reduction | A | A | A | A | AA | AA |
| in moisture | | | | | | |
| migration | | | | | | |
| Flavor | AA | AA | AA | AA | AA | AA |
| Moldability | A | A | A | A | A | AA |

TABLE 16
Change of Bx. with time by difference of
the mannitol content of gum portion (part 2)

| | Ex. 26 | Ex. 27 | Ex. 28 | Ex. 29 | Ex. 30 | Ex. 31 |
|---|---|---|---|---|---|---|
| Bx. | 73.5 | 73.5 | 73.5 | 73.5 | 73.2 | 73.2 |
| Reduction | AA | AA | AA | AA | AA | AA |
| in moisture | | | | | | |
| migration | | | | | | |
| Flavor | AA | AA | A | A | B | B |
| Moldability | AA | AA | AA | A | A | A |

TABLE 17
Change of Bx. with time by difference of
the mannitol content of gum portion (part 3)

| | Com. Ex. 7 | Com. Ex. 8 | Com. Ex. 9 |
|---|---|---|---|
| Bx. | 73.2 | 73.2 | 74.5 |
| Reduction in | AA | AA | C |
| moisture migration | | | |
| Flavor | C | C | A |
| Moldability | C | C | B |

As is apparent from Tables 15 to 17, in the case where the content of mannitol in an LC gum composition according to the present invention exceeds 80 wt %, since the ratio of the gum base becomes low, the moisture migration increases and Bx. increases. However, when the content of mannitol is 73.4 wt % or less, Bx. is low and the moisture migration from a liquid portion to a gum portion is low. Furthermore, when Bx. of Example 20 (mannitol: 73.4 wt %) is compared to that of Comparative Example 9 (mannitol: 80.0 wt %), it is presumed that Bx. decreases and moisture migration decreases when the mannitol content is 75.0 wt % or less. On the other hand, when mannitol is less than 39.0 wt %, even if the moisture migration decreases, flavor and moldability degraded. Based of overall evaluation of the reduction in moisture migration in view of flavor and moldability, it was found that LC gum tablets reduced in moisture migration and having excellent flavor and moldability are obtained generally at a mannitol content of 40.0 wt % to 75.0 wt %, preferably at 40.0 wt % to 73.4 wt %, more preferably, at 54.0 wt % to 65.0 wt %, and most preferably, at 57.5 wt % to 63.0 wt %.

### Examples 32 to 62, Comparative Examples 10 to 18

LC gum tablets were prepared (each having dimensions: 21.7 mm length×15.0 mm width×8.0 mm thickness and a weight of about 1.8 g) in the same manner as in Examples 1 to 31 and Comparative Examples 1 to 9 and subjected to the same evaluation test.

As a result, the results of the changes of Bx. measurement with time did not differ between LC gum tablets (each having dimensions: 17.5 mm length×12.5 mm width×7.5 mm thickness and a weight of about 1.2 g) and the LC gum tablets (each having dimensions: 21.7 mm length×15.0 mm width×8.0 mm thickness and a weight of about 1.8 g).

As is apparent from examples and comparative examples, erythritol and mannitol have the same effect. Even in the case where erythritol and mannitol are used in combination as a sugar component of the gum portion of an LC gum composition according to the present invention, it is apparent that the same effect can be obtained as in the case where erythritol or mannitol is singly used.

This application claims the benefit of Japanese Patent Application No. 2007-208437, filed Aug. 9, 2007, which is incorporated by reference herein in its entirety.

1. A liquid-center gum composition comprising a gum portion and a liquid portion covered with the gum portion, characterized in that the gum portion consists of a sugar component and a gum base and the sugar component contains at least one of erythritol and mannitol.

2. The liquid-center gum composition according to claim 1, wherein a content of the at least one of erythritol and mannitol relative to a total weight of the gum portion is 40.0 wt % to 75.0 wt %.

3. The liquid-center gum composition according to claim 1, wherein a content of the at least one of erythritol and mannitol relative to a total weight of the gum portion is 54.0 wt % to 65.0 wt %.

4. The liquid-center gum composition according to claim 1, wherein a content of the at least one of erythritol and mannitol relative to a total weight of the gum portion is 57.5 wt % to 63.0 wt %.

5. The liquid-center gum composition according to claim 1, wherein a content of the at least one of erythritol and mannitol relative to a total weight of the gum portion is 40.0 wt % to 75.0 wt % and a content of the gum base relative to a total weight of the gum portion is 22.0 wt % to 46.5 wt %.

6. The liquid-center gum composition according to claim 1, wherein a content of the at least one of erythritol and mannitol relative to a total weight of the gum portion is 54.0 wt % to 65.0 wt % and a content of the gum base relative to a total weight of the gum portion is 23.5 wt % to 32.5 wt %.

7. The liquid-center gum composition according to claim 1, wherein a content of the at least one of erythritol and mannitol relative to a total weight of the gum portion is 57.5 wt % to 63.0 wt % and a content of the gum base relative to a total weight of the gum portion is 23.5 wt % to 29.0 wt %.

8. The liquid-center gum composition according to claim 1, wherein the gum portion further contains at least one element selected from the group consisting of a sugar component excluding erythritol, a sweetener, an emulsifying agent, an acidulant, a flavor and a softening agent.

9. The liquid-center gum composition according to claim 1, wherein the liquid portion contains glycerin.

10. The liquid-center gum composition according to claim 2, wherein the liquid portion contains glycerin.

11. The liquid-center gum composition according to claim 3, wherein the liquid portion contains glycerin.

12. The liquid-center gum composition according to claim 4, wherein the liquid portion contains glycerin.

13. The liquid-center gum composition according to claim 5, wherein the liquid portion contains glycerin.

14. The liquid-center gum composition according to claim 6, wherein the liquid portion contains glycerin.

15. The liquid-center gum composition according to claim 7, wherein the liquid portion contains glycerin.

16. The liquid-center gum composition according to claim 8, wherein the liquid portion contains glycerin.
